(19) United States
(12) Patent Application Publication
(10) Pub. No.: US 2011/0210617 A1
(43) Pub. Date: Sep. 1, 2011

(54) POWER TRANSMISSION ACROSS A SUBSTANTIALLY PLANAR INTERFACE BY MAGNETIC INDUCTION AND GEOMETRICALLY-COMPLIMENTARY MAGNETIC FIELD STRUCTURES

(75) Inventor: Mitch Randall, Boulder, CO (US)

(73) Assignee: Pure Energy Solutions, Inc., Boulder, CO (US)

(21) Appl. No.: 12/871,898

(22) Filed: Aug. 30, 2010

Related U.S. Application Data
(60) Provisional application No. 61/238,066, filed on Aug. 28, 2009.
(60) Provisional application No. 61/254,531, filed on Oct. 23, 2009.

(51) Int. Cl. H01F 38/14

(52) U.S. Cl. 307/104

(57) ABSTRACT

Geometrically complimentary magnetic field structures are adapted for efficient power transfer by induction from a planar power delivery surface to a power receiving device. Planar surface electro-magnetic coil pole areas for power delivery and receiver coil assemblies as well as several would coil apparatus and configurations are included.

### CROSS-REFERENCES TO RELATED APPLICATIONS

This application is a nonprovisional application of provisional application No. 61/238,066 filed Aug. 28, 2009, and is also a nonprovisional application of provisional application 61/254,531, filed Oct. 23, 2009, both of which are incorporated herein by reference.

### BACKGROUND OF THE INVENTION

1. Field of the Invention

The present invention relates to electronic systems and methods for providing electrical power and/or data in a wire-free manner to one or more electronic or electrically powered devices with a power delivery surface, and more specifically to such systems and methods wherein the wire-free power transfer is implemented by magnetic induction.

2. State of the Prior Art

A variety of electronic or electrically powered devices, cell phones, laptop computers, personal digital assistants, cameras, toys, game devices, tools, medical devices, navigation devices, and many others, have been developed along with ways for powering them. Mobile electronic devices typically include and are powered by batteries that are rechargeable by connecting them through power cord units, which include transformers and/or power converters, to a power source, such as an electric wall outlet or power grid, an automobile or other vehicle accessory electric outlet plug receptacle, or the like, either during use of the electronic device or between uses. A non-mobile electronic device is generally one that is powered through a power cord unit and is not intended to be moved during use any farther than the reach of the power cord, so it generally does not have or need batteries for powering the device between plug-ins.

In a typical set-up for a mobile device, the power cord unit includes an outlet connector or plug for connecting it to the power source and a battery connector for connecting it to a corresponding battery power receptacle of the battery. The outlet connector or plug and battery connectors are in communication with each other so electrical signals flow between them. In this way, the power source charges the battery through the power cord unit.

In some setups, the power cord unit may include a power adapter, transformer, or converter connected to the outlet and battery connectors through AC input and DC output cords, respectively. The power adapter adapts an AC input voltage received from the power source through the outlet connector and AC input cord to output a DC voltage through the DC output cord. Others include adapters, transformers, or converters connected to the outlet and battery connectors through DC input and DC output cords. The DC output current flows through the receptacle and is used to charge the battery.

In some cases, it is more convenient to provide power to these devices without having to connect or plug in wires, so docking stations are provided, wherein a power delivery device is configured to dock a particular portable electronic or electrically-powered device or battery pack in a manner that connects a set of electrical contacts for delivering power from the docking station to the portable device or battery pack. However, typical docking stations are configured in a manner that is unique to one or a few electronic or electrically-powered device models of a particular manufacturer, thus not useable to charge other devices or battery packs.

To alleviate that problem, several recent innovations have introduced power delivery pads with substantially flat power delivery surfaces on which one or more electronic or electrically powered devices with appropriate power receiver apparatus can be positioned on the power delivery surface to receive electric power. There exist a number of technologies for transferring electric power wire-free to portable electronic or electrically powered devices in this manner.

The foregoing examples of related art and limitations related therewith are intended to be illustrative, but not exclusive or exhaustive, of the subject matter. Other aspects and limitations of the related art will become apparent to those skilled in the art upon a reading of the specification and a study of the drawings.

### BRIEF DESCRIPTION OF THE DRAWINGS

The accompanying drawings, which are incorporated in and form a part of the specification, illustrate example implementations of the present invention, but not the only ways the invention can be implemented, and together with the written description and claims, serve to explain the principles of the invention.

In the drawings:

FIG. 1 is a perspective view of an example inductive power delivery pad, which includes a power delivery surface, and an enabled device with power receiver apparatus positioned on the power delivery surface for receiving electric power, wherein a portion of the top skin of the power delivery surface is cut away to reveal the electro-magnetic coil assembly, and wherein a portion of the shell of the electronic or electrically powered device is cut away to reveal the power receiver coil assembly (for clarity and to avoid unnecessary clutter, the other electronic components normally comprised in an electronic or electrically powered device are not show in this figure);

FIG. 2 is a perspective view of the electro-magnetic coil assembly of the power delivery pad without the housing and surface skin and the receiver coil assembly without the power receiving device shell;

FIG. 3 is a partial cross-sectional view of the core plate and wire coil of the electro-magnetic coil assembly taken substantially along section line 3-3 in FIG. 2;

FIG. 4 is a diagrammatic plan view of the electro-magnetic coil array of the power delivery pad of FIG. 1, showing the example array in alternating north (N) and south (S) elongated strips, along with diagrammatic views of a plurality of example power receivers with respective receiver coil pole constellations positioned in various locations and orientations on the power delivery pad magnetic coil array;

FIG. 5 is a perspective view of the receiver coil assembly turned up-side down to illustrate the structure of the assembly, including the individual coil spools and poles;

FIG. 6 is a cross-sectional view similar to FIG. 3, but with the power receiver coil assembly positioned on the power delivery surface to receive power;

FIG. 7 is a diagrammatic view of four coils showing how they can be electrically connected together;

FIG. 8 is a circuit diagram of the bridge rectifier circuit;

FIG. 9 is a diagram showing the spatial relationship of the pole pieces for an arrangement of four coils;

FIG. 10 is a diagram in plan view of a portion of several strip electro-magnetic pole areas in conjunction with receiver coil pole pieces in a geometrically limiting arrangement;

FIG. 11 is a view similar to FIG. 10, but in a different limiting arrangement;

FIG. 12 is a perspective view of another power delivery surface configuration with rectangular pole areas;

FIG. 13 is a perspective view of a smaller sized power delivery coil assembly;

FIG. 14 is a top plan view of the smaller sized power delivery coil assembly of FIG. 13;

FIG. 15 is a perspective view from the bottom of a power receiver coil assembly;

FIG. 16 is an enlarged isometric view of a portion of the power delivery coil assembly of FIGS. 12-14;

FIG. 17 is a partial cross-sectional view of the power delivery coil assembly taken substantially along section line 17-17 of FIG. 16;

FIG. 18 is a cross-sectional view similar to FIG. 17, but showing the magnetic fields diagrammatically;

FIG. 19 is an isometric view of an embodiment of the power receiver coil assembly poised in a position above the power delivery coil assembly;

FIG. 20 is a circuit diagram of a rectifying regulator circuit for output from the receiver coil assembly;

FIG. 21 is a side elevation view of an embodiment of the power receiver coil assembly poised in a position above the power delivery coil assembly;

FIG. 22 is a side elevation view similar to FIG. 21, but also showing the magnetic fields;

FIG. 23 is an isometric view of two halves of a pot core adapted for use in the power delivery and power receiver coil assemblies; and

FIG. 24 is a cross-sectional view of the two halves of the pot core of FIG. 23, but positioned in alignment with each other for transferring power.

### DETAILED DESCRIPTION OF THE PREFERRED EMBODIMENTS

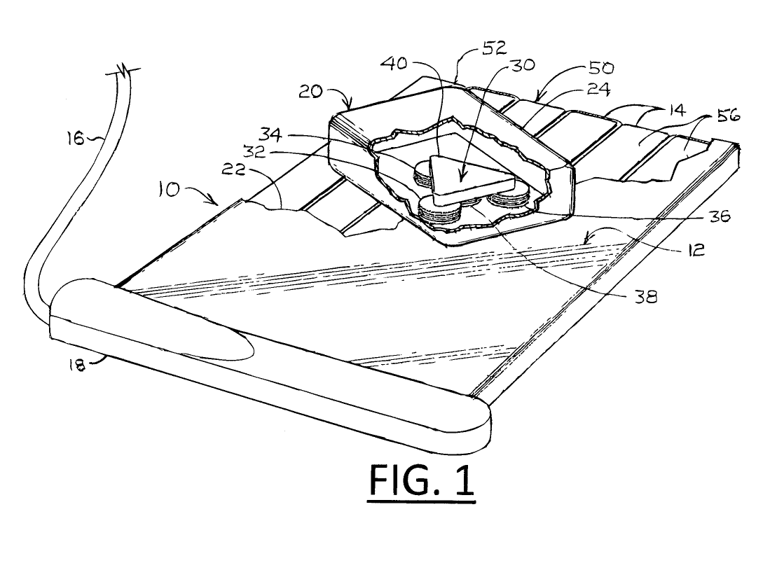

An example power delivery pad 10 and enabled power receiving device 20 are shown in FIG. 1. The power delivery pad 10 transfers power wirelessly or wire-free, i.e., without a charging adapter cord, to one or more devices 20 positioned on it. In this context, the terms “wireless”, “wirelessly”, and “wire-free” are used interchangeably to indicate that charging of the device is achieved without a cord-type electric charging unit or adapter between the power delivery surface 12 of the power delivery pad 10 and the power receiving device, and in the example of FIG. 1, is achieved by magnetic induction with geometrically complimentary magnetic field structures, as will be described in more detail below. Also, the term “enabled” device is used for convenience to mean an electronic or electrically powered device, for example, cell phones, laptop computers, personal digital assistants, cameras, toys, game devices, tools, medical devices, navigation devices, or just about any other portable device, that is equipped with inductive receiver coils and associated electronic circuitry to enable the device to be electrically charged by the power delivery pad 10.

The example power delivery pad 10 and enabled power receiving device 20 in FIG. 1 are shown as one example implementation, but not the only implementation, that demonstrates a number of features and principles used as part of this invention to achieve efficient and reliable wire-free power transfer to power and/or charge a power receiving device. Therefore, this description will proceed with reference to the example shown in FIG. 1, but with the understanding that the invention recited in the claims below can also be implemented in myriad other ways, once the principles are understood from the descriptions and explanations herein, and that some, but not all, of such other implementations and enhancements are also described or mentioned below.

The drawing views of the examples in the accompanying figures of drawings are diagrammatic, not necessarily exact illustrations, and various component sizes and proportions are exaggerated or not true to scale because of the impracticality of illustrating thin layer or component thicknesses and other dimensions in true scale or proportionate sizes, as is understood by persons skilled in the art, but persons skilled in the art can understand the principles and information being illustrated and how to implement them.

Magnetic induction has been employed to implement wire-free power transfer before this invention, but such previous implementations of magnetic induction power transfer have been either inherently low in efficiency, or they require costly electronics. The example implementations described herein provide more efficient, cost effective improvements in wire-free power transfer by magnetic induction.

In the example of FIG. 1, the power receiving device is shown positioned somewhat randomly on the power delivery surface 12 of the power delivery pad 10 to receive electric power, which is provided by magnetic induction from alternating magnetic fields generated by the plurality of strip electro-magnet pole areas or regions 14 in the substantially planar surface 56 a core plate 52 of power delivery pad 10. The strip electro-magnet pole areas 14 are powered to create the alternating magnetic fields, which will be explained in more detail below, by electric power from some electric power source (not shown), such as a wall plug to public utility or grid power, an automobile, boat, airplane, or other vehicle electric power system, a solar electric power generator, or any other source of electric power. The power delivery pad 10 can be connected electrically to any such electric power source by any standard cord 16 or other custom wire connection, as is understood by and within the capabilities of persons skilled in the art, and a magnet driver circuit (not shown in FIG. 1, but described in more detail below) for driving the strip electro-magnet pole areas 14 to produce the magnetic fields can be provided in a suitable housing 18 of the power delivery pad 10 or can be external to the power delivery pad 10. The strip electro-magnet pole areas 14 can be covered by a thin, protective skin or covering material 22, part of which is shown cut away in FIG. 1 to reveal the strip electro-magnets 12, or they can be left exposed, if desired. The skin 22 should be electrically non-conductive and for best power transfer performance, but it might be desirable and feasible to have a magnetic material skin 22. The example power receiving device 20 in FIG. 1 is shown with a portion of its shell or casing 24 cut away to reveal the magnetic pick-up or receiver coil assembly 30, which comprises a plurality of individual receiver coils 32, 34, 36, 38 mounted on a yoke 40. To avoid unnecessary clutter, the other electronic circuits and components typically housed in the shell or casing 24, which would typically include a rechargeable battery pack or storage capacitor and other electronic circuits and components to condition the received power and to operate the device 20 for its intended purpose, are not shown in FIG. 1.

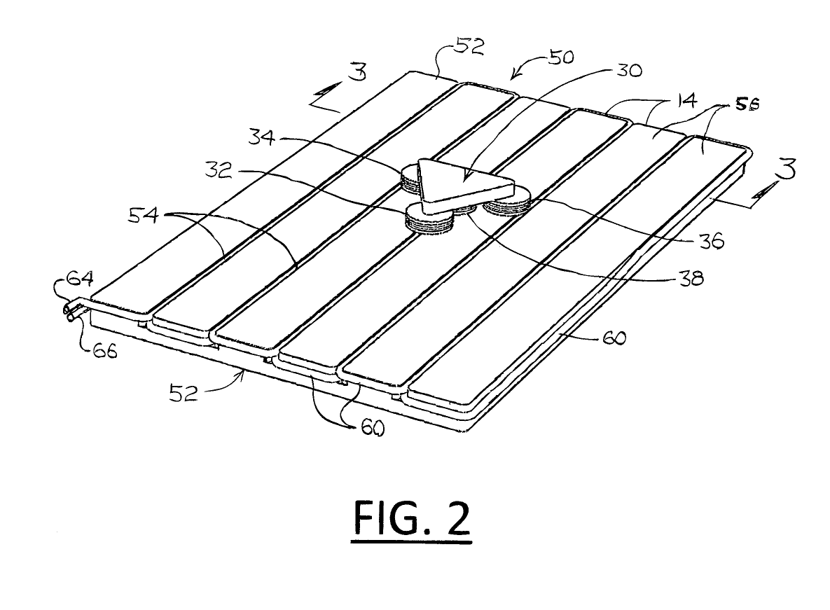

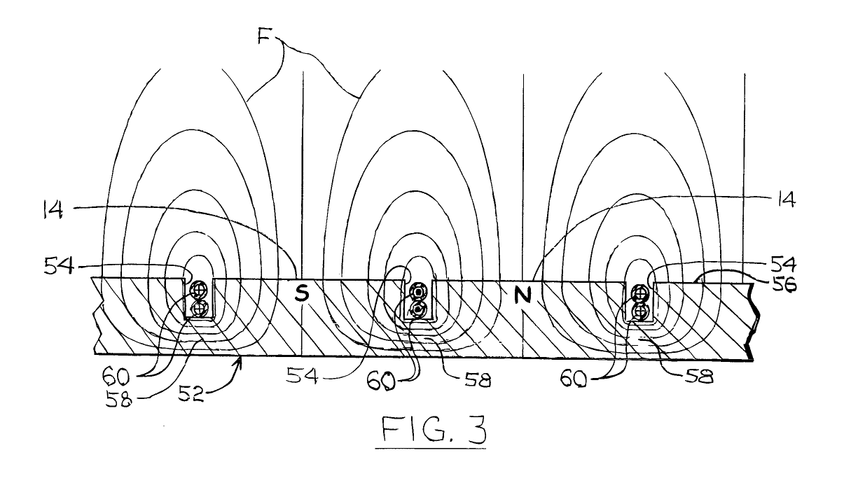

The electro-magnetic coil assembly 50 of the example power delivery pad 10 without the housing and surface skin, and the receiver coil assembly 30 without the shell 24 of the example power receiving device 20 are shown in FIG. 2. As mentioned above, the electro-magnetic coil assembly 50 comprises a plurality of strip electro-magnet pole areas 14 formed side-by-side on the surface 56 of a magnet core plate 52. While the strip electro-magnet pole areas 14 can be formed in myriad ways, the example strip electro-magnet pole areas 14 shown in FIGS. 1 and 2 are formed on a solid plate 52 of soft ferromagnetic material with a plurality of grooves or troughs 54 milled, routed, molded, or otherwise formed in parallel, spaced-apart relation to each other in the upper surface of the plate 52, as shown in FIGS. 2 and 3. One or more coil wire 60 is routed through the troughs 54 around the circumference or perimeter of the individual strip electro-magnet pole areas 14, as illustrated in FIG. 2, so that a current flowing through the coil wire 60 flows around adjacent strip electro-magnets 14 in opposite directions on opposite sides of each strip electro-magnet pole area 14, as illustrated diagrammatically in FIG. 4 by the current flow arrows 62, to generate opposite magnetic polarities in adjacent strip electro-magnet pole areas 14, as also illustrated in FIGS. 3 and 4. In FIG. 4, the plus sign “+” in the wire 60 indicates current flowing in the direction into the paper, and the dot “•” in the wire 60 indicates current flowing in the direction out of the paper, in the conventional manner. In practice, the current flow in the direction of the arrows 62 and the opposite north N and south S polarities in the adjacent strip electro-magnet pole areas 14 are instantaneous indications, because the current is driven as alternating current (AC). Consequently, the current flow direction alternates to opposite directions, and the resulting N and S polarities in adjacent strip electro-magnet pole areas 14 also alternate to opposite polarities, at whatever frequency the AC current is driven, as will be understood by persons skilled in the art. The wire 60 can be insulated, and the ends 64, 66 of the wire 60 (FIG. 2) terminate in the coil driver circuit (not shown in FIG. 2), which can be located in the housing 18 (FIG. 1) or at any other convenient location. The ferromagnetic material of the core plate 52 is preferably, but not necessarily, an electrically non-conductive material to avoid inducing eddy currents in the core plate 52 by the magnetic field, which would decrease efficiency.

The surface 56 of the core plate 52 is preferably, but not necessarily, substantially planar, so the strip electro-magnetic pole areas 14 formed on the surface 56, as described above, result in a substantially planar pattern or array of substantially planar magnetic pole areas or regions 14, separated by the troughs 54, on which the power receiving device 20 can be positioned, with or without the protective skin 22, to receive power inductively. The troughs 54 in the example illustrated in FIGS. 1-3 are not deep enough to completely separate the strip electro-magnetic pole areas 14 so that a portion 58 of the core plate 52 is left under each trough 54 to provide a magnetic flux F path under each trough 54 to complete the magnetic circuit between adjacent strip electro-magnetic pole areas 14, as illustrated in FIG. 3. In general, the magnetic field lines F created by the excitation current flowing through the wire 60 extend from a strip electro-magnetic pole area 14 into the immediate vicinity above the pole area 14 and over to an adjacent pole area 14, which by design is of opposite polarity, as illustrated in FIG. 3. The field lines F continue within the ferromagnetic core plate 52 and through the material path 58 under the trough 54 and back through the ferromagnetic material to form continuous lines of flux F.

In this regard, it should be noted that the troughs 54 are not required. The coil current carrier function provided by the wire 60 in the trough 54 could be provided in other ways, for example, but not for limitation, a planar conductor strip (not shown), such as a copper tape, could be adhered to the surface 58 of the core plate 52 around the peripheries or perimeters of respective surface areas 14 to form and create the strip electro-magnetic pole areas 14. In another example implementation (not shown), no ferromagnetic material is used for the core plate 52 (or otherwise), and the wire windings 60 themselves create and define the geometry to satisfy the basic principles of operation of the power delivery pad 10, although, without the ferromagnetic plate 52, the magnetic field flux lines 12 would not concentrate in paths through the core plate, but, instead, would extend below the wires 60 in a similar manner to the flux lines F above the core plate 52 illustrated in FIG. 3. It is appropriate to also note that in the implementation shown in FIGS. 1-3 as well as in implementations in which no ferromagnetic material is used, when no receiver device 20 is nearby, a large portion of any one field F does not pass through ferromagnetic material.

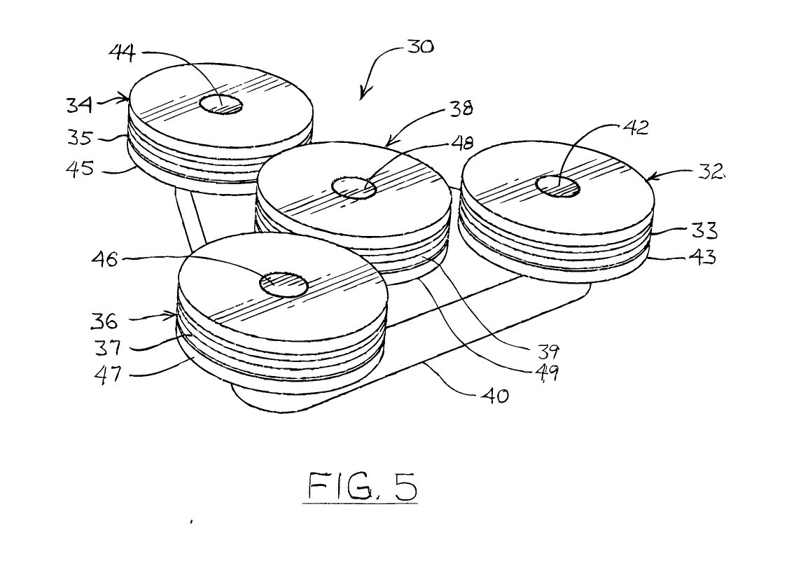

As shown in FIGS. 1 and 2 and explained above, the power receiving device 20 is equipped with a the receiver coil assembly 30. As best seen in FIG. 5, in conjunction with FIGS. 1 and 2, the receiver coil assembly comprises a plurality of receiver coils 32, 24, 36, 38. Each receiver coil 32, 34, 36, 38 in the example implementation illustrated in FIGS. 1, 2, and 5 comprises a wire winding 33, 35, 37, 39, respectively, wound onto a bobbin or spool 43, 45, 47, 49, respectively. The wire windings 33, 35, 37, 39 can be insulated copper wire or other wire suitable for windings as is known in the art. Each bobbin or spool 43, 45, 47, 49 is mounted on a pole piece 42, 44, 46, 48, respectively, that extends from the yoke core 40. The yoke core 40 and the pole pieces 42, 44, 46, 48 comprise a soft ferromagnetic material.

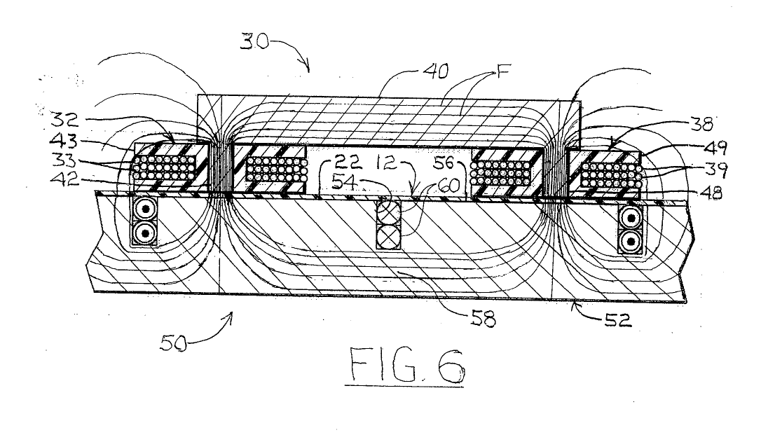

When a power receiving device 20 is positioned on the power delivery surface 12 of the power delivery pad 10, as shown in FIG. 1 in a manner in which at least one of the receiver pole pieces 42, 44, 46, 48 is aligned with a strip electro-magnetic pole area 14 of one polarity (e.g., N) and at least a different one of the receiver pole pieces 42, 44, 46, 48 is aligned with a different strip electro-magnetic pole area 14 of the opposite polarity (e.g., S), as illustrated in the cross-sectional FIG. 6, a magnetic circuit indicated by magnetic flux lines F is formed between the electro-magnetic pole areas 14 of the surface 56 of the core plate 52 and the pole pieces (e.g., pole pieces 42, 48 in FIG. 6) of the power receiver coil assembly 30. In this manner, the electromagnetic coil assembly 50 of the power delivery pad 10 and the receiver coil assembly 30 of the power receiving device 20 essentially form a transformer with the magnetic flux F generated by the excitation windings formed by the wire 60 of the core plate surface 56 pass through the ferromagnetic material of the pole pieces 42, 48 and yoke core 40 of the power receiver coil assembly 30. This magnetic flux F induces a voltage in the windings 33, 39 of the receiver coil assembly 30, which can be used to charge and/or operate the power receiving device 20, as will be explained in more detail below.

In a practical implementation, as shown in the example of FIGS. 1 and 6, a gap formed by the non-ferromagnetic material of skin 22 on the power delivery surface 12 of the power delivery pad 10 separates the electro-magnetic pole areas 14 of the core plate 56 from the receiver pole pieces (e.g., pole pieces 42, 48 in FIG. 6). The non-ferromagnetic material of the shell 24 of the power receiving device 10 (shown in FIG. 1, but not in FIG. 6) can also provide part of this gap, if the power receiving device 10 is constructed with the receiver pole pieces 42, 44, 46, 48 inside the shell 24 and not protruding through the shell 24. The non-ferromagnetic material of the skin 22 can be a protective covering that hides and otherwise secures the inner components of the electro-magnetic coil assembly 40. This gap becomes part of the overall magnetic circuit F as shown in FIG. 6, when the power receiving device 20 is positioned on the power delivery surface 12.

As mentioned above, power is transferred from the power delivery surface 12 to the power receiving device 20 through the changing (alternating) magnetic flux F induced in the magnetic circuit. This flux F is induced by exciting an AC current in the power deliver surface windings formed by the wire(s) 60. The AC frequency can be chosen as a matter of design to balance trade-offs between efficiency and losses.

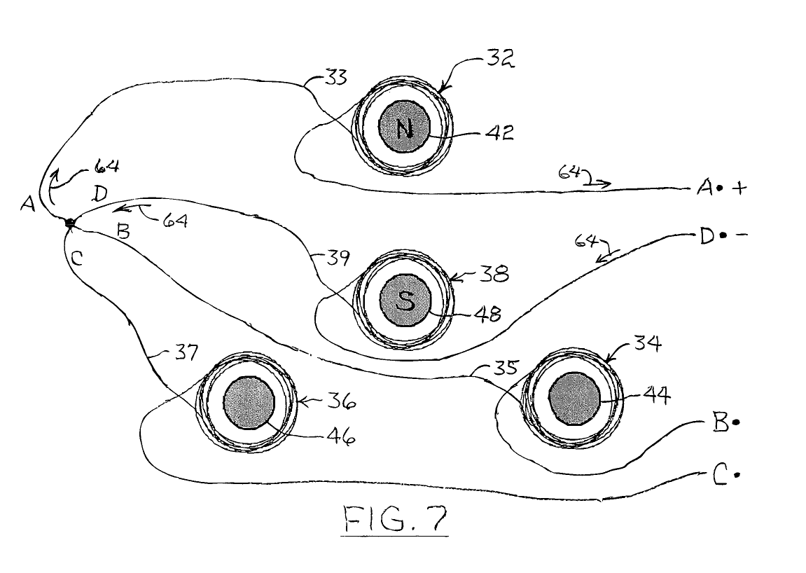

As also mentioned above, the receiver pole pieces 42, 44, 46, 48, when placed on the power delivery surface 12, will efficiently link flux F from the electro-magnetic pole areas 14 of the core place surface 56, and, as long as at least one receiver pole piece links to a pole area 14 of N polarity and at least one other pole piece links to a pole area 14 of S polarity, power can in principle be extracted from the power delivery surface 12 and delivered to the power receiving device 20. To illustrated this principle, the plurality of receiver coils 32, 34, 36, 38 are illustrated diagrammatically in FIG. 7, with one end of each respective coil wire 33, 35, 37, 39 connected together at a common node as indicated by A, B, C, D, respectively, and the other end of each respective coil wire 33, 35, 37, 39 terminating at A dot, B dot, C dot, and D dot, respectively. The receiver coil 32 is illustrated for example with its pole piece 42 linked to a magnetic N polarity pole area 14 (not shown in FIG. 7), and the receiver coil 38 is illustrated in this example with its pole piece 48 linked to a magnetic S polarity pole area 14 (not shown in FIG. 7). The other two receiver pole pieces 44, 46 of receiver coils 34, 36 are shown in this example with no polarity link, such as if they were aligned over a trough 54. In this example, the A dot end of the coil wire 33 of receiver coil 32 would be of one electrical polarity, e.g., positive (+), and the D dot end of the coil wire 39 of receiver coil 38 would be of the opposite electrical polarity, e.g., negative (−), so electric current would flow through the wires 33, 39, as indicated by arrows 64. Since the pole pieces 44, 46 of the other two receiver coils 34, 36 are not linked to any polarity pole area in this example, no electric current is flowing through their wires 35, 37. Any other combination of at least one receiver pole piece linked to one magnetic polarity (e.g., N) and at least one other receiver pole piece linked to the opposite magnetic polarity (e.g., S) will result in current flow in one direction or another.

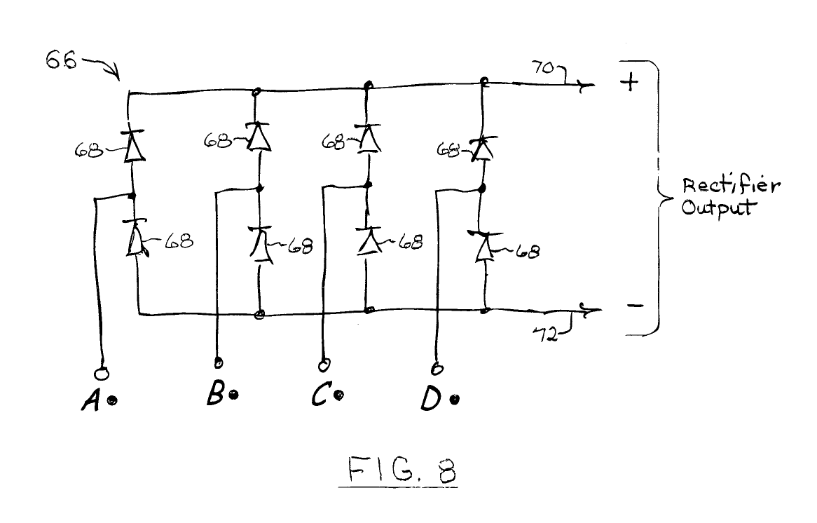

A bridge rectifier circuit 66 as shown, for example, in FIG. 8 can be used to rectify any combination of current flows of either electrical polarity, e.g., positive (+) or negative (−), from the wire ends A dot, B dot, C dot, and/or D dot of the coil wires 33, 35, 37, 39 in FIG. 7 as explained above. A pair of diodes 68 in a parallel circuit for each coil wire 33, 35, 37, 39 (A dot, B dot, C dot, D dot, respectively) with the wires 33, 35, 37, 39 connected into the parallel diode rectifier circuit between the two diodes 68 is sufficient to extract usable electric power whenever at least one receiver pole piece is linked to one magnetic polarity (e.g., N) and at least one other receiver pole piece is linked to the opposite magnetic polarity (e.g., S), as explained above. The rectifier output, as indicated in FIG. 8, is a direct current on two terminals 70, 72, one always positive and the other always negative, which can be conditioned and regulated for use by the power receiving device 20.

In the example implementation shown in FIGS. 1-4, there are four receiver pole pieces 32, 34, 36, 38 shown in a pattern wherein three of the pole pieces 32, 34, 36 are positioned at the vertices of an equilateral triangle and the fourth pole piece 38 is positioned in the center of the equilateral triangle. This arrangement is sometimes called a tetrahedron pattern, because the positions of the four pole pieces are at locations that match the appearance of the vertices of a top plan view of a tetrahedron. Other numbers and arrangements of receiver pole pieces can also be used.

When the pole pieces 32, 34, 36, 38 in the tetrahedron pattern as explained above are appropriately spaced apart from each other in relation to the width of the strip electro-magnetic pole areas 14 of the power delivery pad 10, as will be explained below, there can be one hundred percent assurance that any location and any orientation of the power receiving device 10 on the power delivery surface 12 of the power delivery pad 10 will result in at least one receiver pole piece is linked to one magnetic polarity (e.g., N) and at least one other receiver pole piece is linked to the opposite magnetic polarity (e.g., S), thus power transfer to the power receiving device 10. Six example placements of the tetrahedron pattern of receiver pole pieces 32, 34, 36, 38 with appropriate spacing in relation to the strip electro-magnetic pole areas 14 are illustrated in FIG. 4. The example 74 has two receiver pole pieces linked to a N polarity pole area 14, one receiver pole piece linked to a S polarity pole area 14, and one receiver pole piece not linked to any pole area 14, e.g., positioned over a trough 54. The example 76 has two receiver pole pieces linked to a S polarity pole area 14, one receiver pole piece linked to a N polarity pole area 14, and one receiver pole piece not linked to any pole area 14, e.g., positioned over a trough 54. The example 78 has one receiver pole piece linked to a N polarity pole area 14, one receiver pole piece linked to a S polarity pole area 14, and two receiver pole pieces not linked to any pole area 14, e.g., positioned over a trough 54, which is the same as the example shown in FIG. 7 and described above. The example 80 also has two receiver pole pieces linked to a N polarity pole area 14, one receiver pole piece linked to a S polarity pole area 14, and one receiver pole piece not linked to any pole area 14, e.g., positioned over a trough 54. The example 82 also has one receiver pole piece linked to a N polarity pole area 14, one receiver pole piece linked to a S polarity pole area 14, and two receiver pole pieces not linked to any pole area 14, e.g., positioned over a trough 54, which is the same as the example shown in FIG. 7. The example 84 has two receiver pole pieces linked to a S polarity pole area 14, one receiver pole piece linked to a N polarity pole area 14, and one receiver pole piece not linked to any pole area 14, e.g., positioned over a trough 54.

A central principle of the present invention is the relationship between the geometry of the pole areas 14 of the power delivery surface 12 and the geometry of the receiver pole pieces 32, 34, 36, 38 of the power receiver 10, as explained above. The term “power transfer probability” is used to indicate the statistical probability that a given position and orientation of the power receiving device 10 in proximity with and relative to the power delivery surface 12 will allow for power delivery. Power transfer probability is a function of the geometry of the system, and refers to the probability that at least one receiver pole piece 32, 34, 36, 38 is well coupled to a pole area 14 and of polarity North, and at least one other receiver pole piece 32, 34, 36, 38 is well coupled to another pole area 14 of polarity South. Since magnetic induction link or coupling probability is a function of the system geometry, it is invariant under geometrical scaling. The example implementation shown in FIGS. 1-4 is capable of maintaining a 100% power transfer probability. Further, the geometry can be chosen through appropriate selection of parameters (defined below) to guarantee a minimum degree of coupling that the relevant poles of the receiver will afford for all positions and orientations of the power receiving device 20 on the power delivery surface 12.

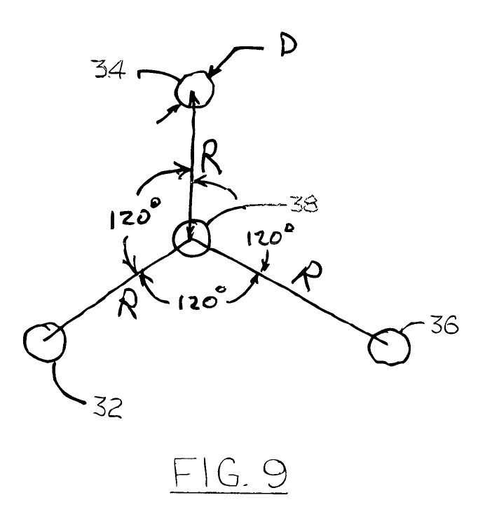

The following derivation guarantees that at least two receiver pole pieces of the receiver coil assembly 30 that are engaged in transferring power are fully positioned above pole areas 14 of the power delivery surface 12. That is to say that the relevant receiver pole pieces of the receiver coil assembly 30 are not partially extending beyond the boundary of the pole areas 14 of the power delivery surface 12, which they are engaging. For purposes of this derivation, the geometry of the receiver pole pieces 32, 34, 36, 38 are defined as shown in FIG. 9, and the first limiting case is shown in FIG. 10. In this case, defined by the positioning of the center receiver pole piece 38 and an outer receiver pole piece 32, 34, or 36 resting across width W of the strip electro-magnetic pole area 14, the parameter R cannot be larger than W−D, where D is the diameter of the receiver pole pieces 32, 34, 36, 38. If so, a position could be found where neither is fully over the pole area 14, in violation of the limiting assumption above. Simply,

R≦W−D

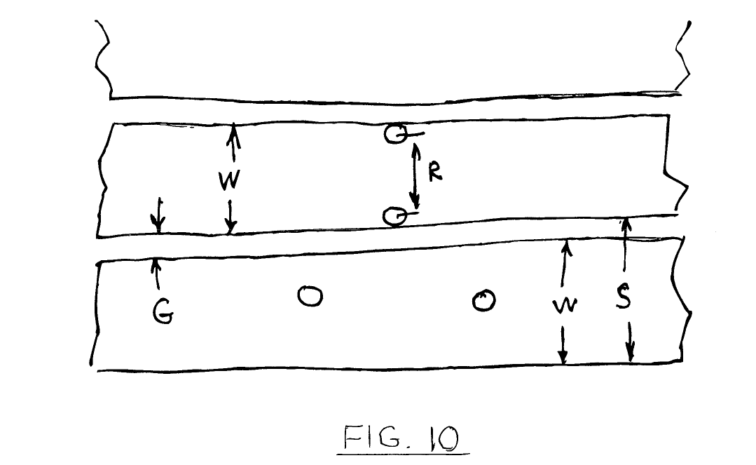

The second limiting case is shown in FIG. 11. In this case, defined by all of the outer receiver pole pieces 32, 34, 36 being positioned over like-polarized pole areas 14, R is bounded by:

$$R \geq \frac{2}{3} ( W + 2 G + D )$$

A space of solutions exists between these two limits. However, given the following considerations, there exists an optimum within this space. It is assumed to be preferred that the diameter of the contacts be smaller than the width of the insulating gap such that the contacts cannot “short circuit” the fields between adjacent pole areas 14. It is also assumed to be preferred that the diameter of the receiver pole pieces 32, 34, 36, 38 be as large as possible to maximize transformer coupling. Therefore, it is preferred that the diameter D of the receiver pole pieces 32, 34, 36, 38 be slightly smaller than the width G of the troughs 54. The diameter D can be expressed as a fraction K of the trough 58 width G:

D=KG

Where

0 [symbol] K≦1

Substituting into the above equations gives

$$R \leq W - KG$$

$$and$$

$$R \geq = \frac{2}{3} ( W + 2 G + KG )$$

Combining equations, therefore

$$W - KG = \frac{2}{3} ( W + 2 G + KG )$$

so

W=(4+5K)G

or

S=(5+5K)G

In summary, given a grid spacing S,

$$G = \frac{1}{5 + 5 K} S$$

$$W = \frac{4 + 5 K}{5 + 5 K} S$$

$$R = 0.8 S$$

$$D = \frac{K}{5 + 5 K} S$$

If K=0.9, then:
G=0.10526 S
W=0.89472 S
R=0.80000 S
D=0.09474 S

The following table lists coefficients of S for various other values of K.

| | K | | | | | | |
|---|---|---|---|---|---|---|---|
| | 0 | 0.4 | 0.6 | 0.7 | 0.8 | 0.9 | 1 |
| G | 0.20000 | 0.14286 | 0.12500 | 0.11765 | 0.11111 | 0.10526 | 0.10000 |
| W | 0.80000 | 0.85714 | 0.87500 | 0.88235 | 0.88889 | 0.89474 | 0.90000 |
| R | 0.80000 | 0.80000 | 0.80000 | 0.80000 | 0.80000 | 0.80000 | 0.80000 |
| D | 0.00000 | 0.05714 | 0.07500 | 0.08235 | 0.08889 | 0.09474 | 0.10000 |

Various engineering requirements may define the selection of K—the ratio of the size of the each receiver pole piece 32, 34, 36, 38 compared to the width of the troughs 54 of the surface 56 of the core plate 52 of the power delivery pad 10. Since field lines F fringe in the area of discontinuities and since, in practice, there will always be an air gap between coupled poles, K may not be simply chosen to be 1.0 as simple assumptions may imply.

An example variation of the example electro-magnetic coil assembly 50 described above does not use ferromagnetic materials, but rather uses air-wound coils. In this example variation, the coils are held in place by a non-ferromagnetic material such as plastic or epoxy-fiberglass arranged in the same shape as the example implementation described above. The magnetic fields on the power delivery surface have alternating polarities from coil to coil at any single instant in time, and the field structure is defined by the placement of the conductors. Likewise, the power receiver can also contain no ferromagnetic material, and its response to external fields is defined by the placement of its conductors. Analogous to the principles used in the case of a ferromagnetic material-based implementation, the non-ferromagnetic-material-based implementation benefits from the geometry described above. In this case, flux linkage is significantly enhanced by the geometry. If this non-ferromagnetic optional implementation is used, applications requiring significant power transfer would preferably make use of resonant coupling to increase the efficiency of the power transfer.

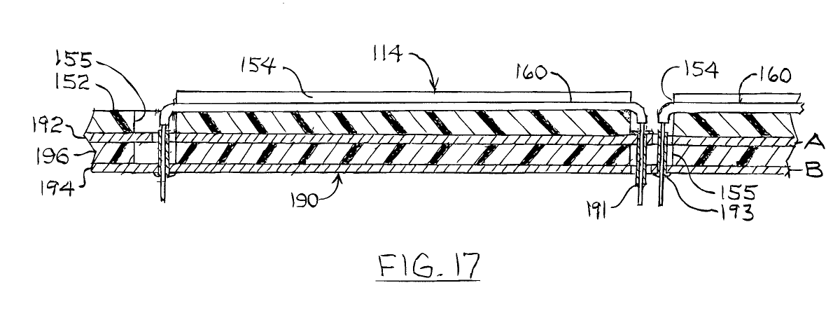

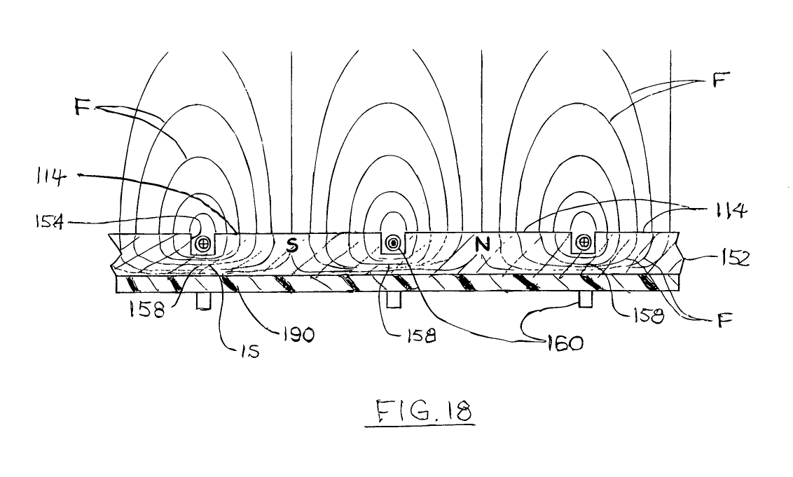

While the example implementation described above provides one hundred percent assurance of power transfer, regardless of the location and orientation of the power receiving device 20 on the power delivery surface 12 of the power delivery pad 10, there may also be applications in which a requirement for placement of a power receiving device 20 at one discrete location and/or orientation on the power transfer surface 12 or placement at one of a plurality of discrete locations and discrete orientations is desirable or at least tolerable. Therefore, another example embodiment of the invention is illustrated in FIGS. 12-22 to accommodate efficient power transfer under these circumstances.

To provide this kind of alternative embodiment, an alternative core plate 152 with the grooves or troughs 154 milled, routed, or otherwise formed into the surface 156 of the core plate 152 in a grid pattern along parallel and perpendicular lines is provided form an electro-magnetic coil assembly 150 with a two-dimensional array of rectangular pole areas 114 in the core plate surface 156, as shown in FIG. 12. In this example, the rectangular pole areas 114 are shown as squares, although square rectangles are not required. A power receiving device 120 is shown in FIG. 12 positioned on the core plate surface 156 of the electro-magnetic coil assembly 150 in lateral and rotational alignment with the rectangular pole areas 114, although it may be desirable to provide a skin or cover over the core plate surface, as shown by the skin 22 in FIG. 1 for the first example power delivery pad 10.

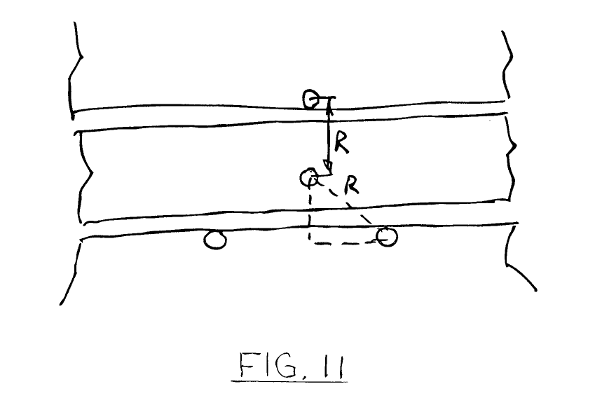

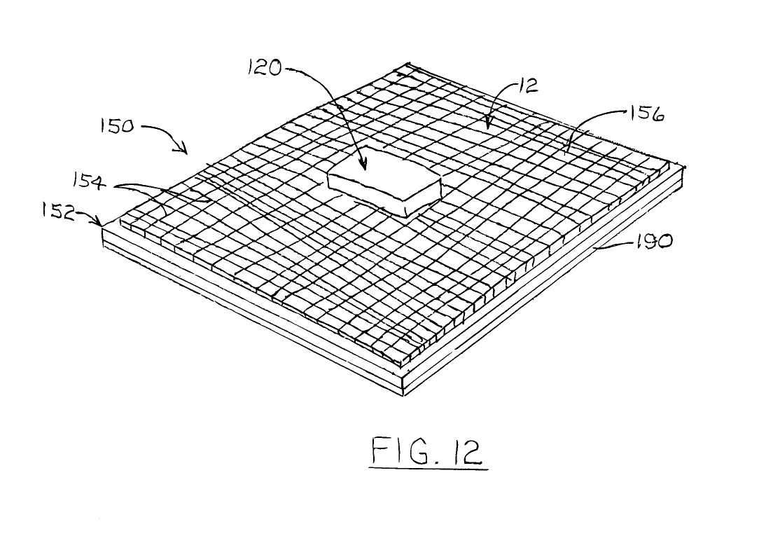

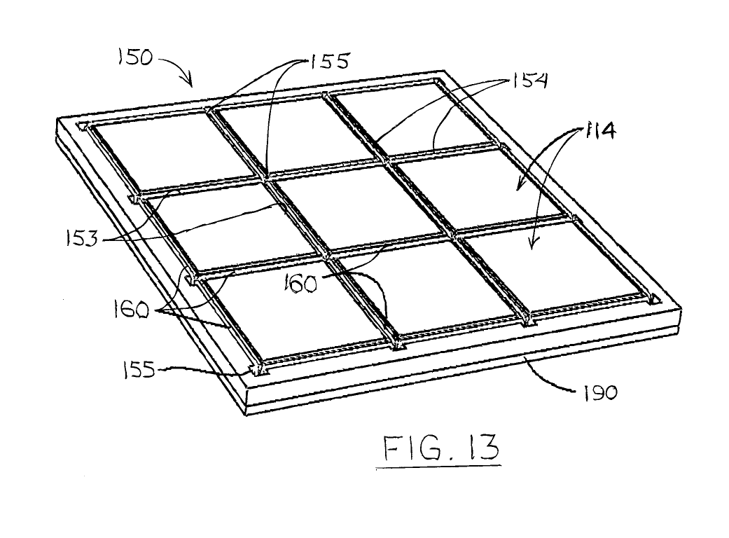

As best seen in FIG. 13 in conjunction with FIG. 12, this example implementation comprises a substantially planar pattern or array of electro-magnetic pole areas 114 to form a power delivery surface 112 with or without a protective skin or covering (not shown). The enlarged example electro-magnetic coil assembly 150 is shown in FIG. 13 in a small version or configuration comprising only nine electro-magnetic pole areas 114 for convenience and to accommodate the enlargement in order to illustrate more clearly the structural details. In one example implementation, the core plate 152, including the core plate surface 156, comprises ferromagnetic material, although ferromagnetic material for the core plate is not essential. Wire conductors 160 are positioned in the grooves or troughs 154 to extend along adjacent the sides or edges 153 of the electro-magnetic core areas 114 and then extend downwardly through holes 155 at the intersections the troughs 154 adjacent the corners of the electro-magnetic pole areas 114. Therefore, each electro-magnetic core area 114 is surrounded on all of its perimeter edges 153 by at least one wire 160. The wires 160 extend through the holes 155 to a printed circuit board 190 under the core plate 152, which energizes and drives wires 160 to generate the alternating magnetic field in the electro-magnetic pole areas 114.

The resulting magnetic polarities of alternating magnetic fields in the electro-magnetic pole areas 114 are illustrated diagrammatically in FIG. 14, which is a plan view of the small version depiction of the electro-magnetic coil assembly 150 in FIG. 13. The arrows in FIG. 14 represent the instantaneous direction of current flow around each substantially planar pole region or area 114 at a single moment in time, which reverses and alternates based on the frequency of the driving AC voltage. Inductive power transfer requires a changing magnetic field which, in this embodiment, is provided by an alternating electrical current supplied to the conductive wires 160 surrounding each electro-magnetic pole area 114. The arrows represent the direction of the alternating current at a single moment in time to demonstrate the principle of operation. Each pole area 114 is labeled N or S indicating North or South magnetic polarity respectively at a single instant in time, which, of course, alternates as the electric current in the wires 160 alternates. This polarity labeling is intended to aid in demonstrating the principle, since in operation the polarity of each pole 155 region would be alternating as prescribed by the alternating current in their respective circumferential windings 160.

In this example, the power receiving device 120 (FIG. 12) derives power from the core plate surface 156 of the power delivery surface 12 by virtue of alternating magnetic flux that passes from the power delivery surface 12 to the power receiving device 120. In one embodiment the power receiver 120 that is designed to obtain power from the core plate surface 156 shown in FIG. 14 has a receiver coil assembly 130 as shown in FIG. 15 with the same number and size of electro-magnetic pole areas 144 as does the power delivery surface 150. In this way, when the receiver coil assembly 130 of the power receiving device 120 is aligned atop the electro-magnetic coil assembly 150 of a power delivery pad (with their ferromagnetic pole areas 144, 114, respectively, facing each other) they transfer power efficiently from the electro-magnetic core assembly 150 to the receiver core assembly 130. When a receiver coil assembly 130 of a power receiving device 120 is placed on a core plate surface 156 of a power delivery surface 12, as explained above, there is necessarily an air gap that dominates the overall reluctance of the paths traced by the coupled lines of magnetic flux. The larger the cross-sectional area of the air gap, the less the reluctance that the air gap causes. An important feature of this example magnetic core assembly 150 and receiver coil assembly 130 is that the cross-sectional area of the air gap between them is very large, approaching the available size of the power receiver 120.

FIG. 4 shows a close-up of how power is supplied to the wire windings 160 and how the wire windings 160 are routed from the holes 155 into the troughs 154 to extend along respective edges 153 of the electro-magnetic pole areas 114. In this example embodiment, a printed circuit board 190 has at least two electrically conductive layers 192, 194 separated by a non-conductive or dielectric material 196, for example, epoxy fiberglass, as illustrated diagrammatically in FIG. 17. One of the electrically conductive layers 192, 194 has an electrical potential (voltage) A, and another of the two layers 192, 194 has an electric potential (voltage) B. The wire conductors 160 are then connected to the printed circuit board 190 with one end connected electrically at 191 to layer 192 at the potential A and the other end connected electrically at 193 to layer 194 at the potential B to produce the current-flow diagram (see arrows) of FIG. 14. In this way each wire 160 is being energized by the potential difference of plane A and plane B. These two planes or layers 192, 194 form a parallel plate capacitor. Each of the wires 160 provide an inductance connected across the potential AB. The parallel combination of the capacitor formed by the planes A and B of conductive layers 192, 194 of printed the circuit board 190, and the wires 160 thereby form a tank circuit with a resonant frequency.

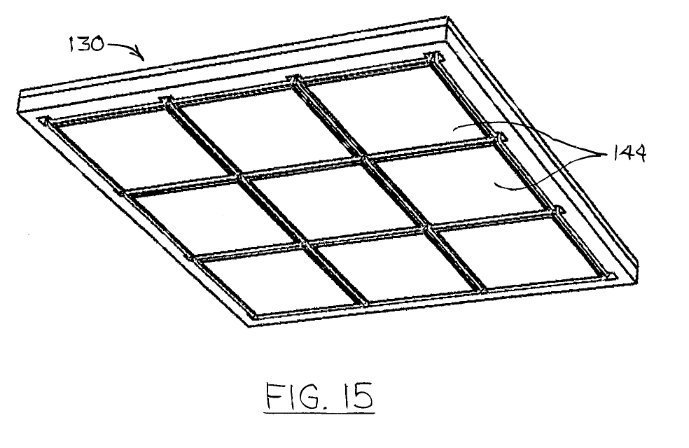

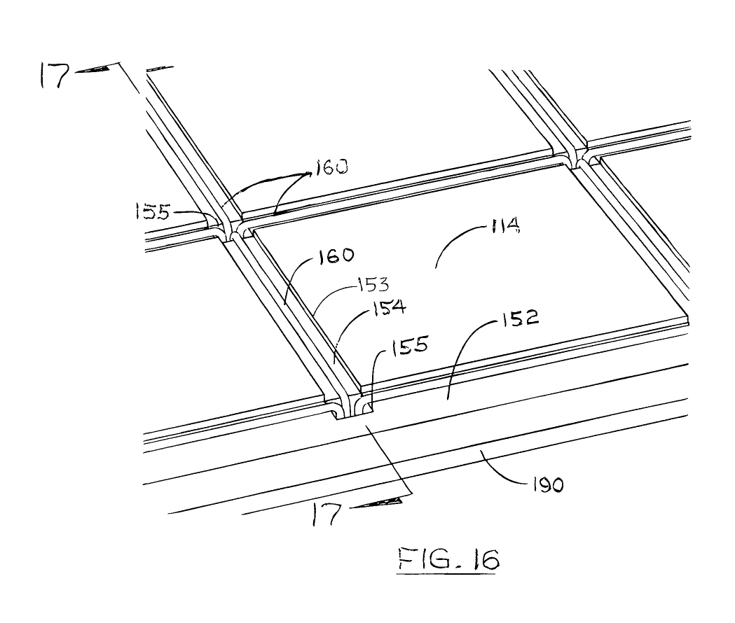

In one embodiment, the core plate surface 156 is formed of a ferromagnetic material shaped to provide rectangular pole areas 114, as seen from above as depicted in FIGS. 12-14. Further, in one embodiment, the pole areas 114 are delineated by troughs 154 as can be seen in FIGS. 13, 14, 16, and 17. Within the troughs 154 are one or more conductors 160 that carry an alternating current. FIG. 18 shows these conductors 160 in cross section and with the convention that a plus sign indicates current flowing away from the viewer, and a dot indicates current flowing towards the viewer. The polarities of the pole areas 114 and the direction of the currents in the wires 160 shown in FIG. 16 is intended to illustrate, for the purpose of description, the principle of operation of this example embodiment. The particular polarities and directions shown represent a snapshot in time, as in operation, these polarities and directions are alternating.

The troughs 154 are not deep enough to separate the pole areas 114. Rather a path 158 is left under each trough 154 to allow the completion of a magnetic circuit between adjacent pole areas 114. It should be noted that troughs 154 are not a required feature of this invention but are describes as one particular embodiment. Other means for providing the coil current to define the pole areas 114 can be used, for example, but not for limitation, strips of copper tape (not shown) applied to the surface 156.

In general, magnetic field flux lines F created by the excitation current extend from a pole area 114 of the surface 156 into the immediate vicinity above the pole area 114 and over to an adjacent pole area 114, which by design is of opposite polarity. The field lines F continue within the ferromagnetic material 158 of the core plate 152 under a trough 155 and back through the ferromagnetic material 152 to form continuous lines of flux F. Note that with no devices nearby, a large portion of any one flux line F does not pass through ferromagnetic material 152.

In another embodiment (not shown), no ferromagnetic (or otherwise) material is used, and the windings themselves create and define the necessary geometry to satisfy the basic principle of operation herein disclosed.

The power receiving device 120 comprises a power receiving assembly 130 that includes a set of pole areas 144 with substantially the same size and shape as the pole areas 114 on the core plate surface 156 of the power delivery surface. One difference is that the number of pole areas 144 on the power receiving assembly 130 may be different than the number of pole areas 114 on the power delivery coil assembly 150. In one embodiment, the pole areas 114 are arranged as a grid with a period of, for example, 10 mm in both orthogonal axes along the surface. In one example embodiment, the number of pole areas 114 on the core plate surface 156 of the power delivery coil assembly 150 is 400. Also in one example embodiment the power receiver assembly 130 intended to extract power from the core plate surface 156 is comprised of nine pole areas 114.

In one example embodiment, the construction of the power receiver assembly 200 is identical to the construction of the power delivery magnetic coil assembly 150. Because of the identical construction, the power receiver assembly 130 resonates at the same frequency as the power delivery magnetic coil assembly 150. If not, parallel capacitors can be added or adjusted to ensure the resonant frequencies match.

In one example embodiment, the output of the power receiver assembly 130 is an alternating signal across the parallel plates 192, 194 of the printed circuit board 190 as described above. In another example embodiment, an alternating potential is induced in a pair of wires that form windings around the pole areas 144 of the power receiver assembly 130. In either case, a DC potential can be obtained by rectification.

In another example embodiment, a pulse width modulated rectifier is used to extract DC power from the alternating potential from the receiver pole area 144 windings. In this case, pulse width modulation is used to adjust the rectified potential derived from the alternating potential to regulate the output voltage. FIG. 20 shows the means by which an alternating potential can be converted to a regulated DC potential labeled Vo, including, for example, a buck regulator circuit 202 or switch mode power supply. A controller can be used to adjust the pulse width modulation switch 201 shown in FIG. 20 to the proper operating point to achieve the desired output voltage Vo, as is understood by persons skilled in the art. In another example embodiment, the pulse width modulated switch is combined with the bridge rectifier 203 such that the bridge rectifier 203 conducts for only a portion of the time. In this way, a more cost effective and efficient conversion from alternating potential to output voltage Vo can be obtained.

It may be desirable for a variety of reasons, including efficient power transfer, to align the power receiver assembly pole areas 144 with the pole areas 114 of the power delivery coil assembly 150. An advantage of some of the example embodiments described herein is that many optimum relative alignment positions are available such that means are possible to adjust a randomly placed power receiving device 120 to a nearby optimum position on the power delivery magnetic coil assembly 150. One example implementation of such alignment includes use of very thin magnetic material, for example, but not for limitation, rubberized magnetic material similar to that used for common refrigerator magnets, but polarized in a way similar to the matrix of pole areas 114 on the core plate surface 156 of the power deliver coil assembly and the pole areas 144 of the power receiver assembly 130. In this example embodiment, the polarized magnetic material is very thin and is adhered to the pole-side surface of both the power core plate surface 156 and the power receiver assembly 130. For example, such thin magnetic material could also serve the purpose of the protective cover 22 in FIG. 1. With such an arrangement, the magnetic materials of both surfaces tend to align themselves together in a position that is optimum for power transfer. For example, if a power receiver assembly 130 was to be placed randomly on a core plate surface 156 of the power delivery coil assembly 150, in such a position that the poles were not in good alignment, the magnetic materials adhered to each surface would cause the power receiving device 120 position and orientation to translate on the power delivery surface 12 as a result of opposite magnetic poles pulling together. By design, this kind of alignment correction can bring the power receiving device 120 into proper position in relation to the surface 156 of the power delivery coil assembly 150 such that optimum power transfer can be achieved.

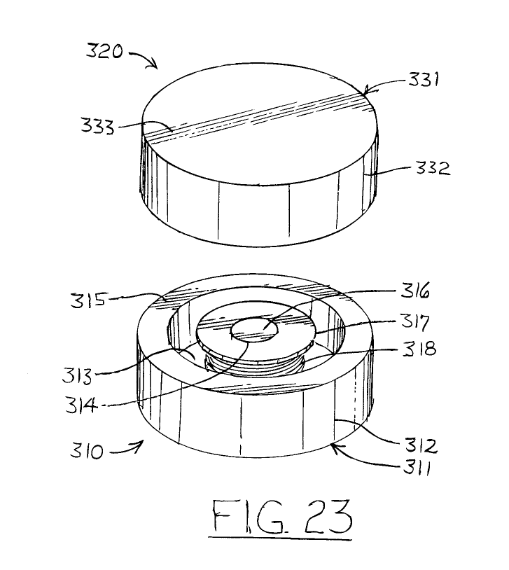

When a power receiving device 120 rests on a power delivery surface 156, a magnetic circuit is formed between the pole area 114 of the power delivery surface 156 and the pole areas 144 of the power receiving device 120. As a result, magnetic flux passes between the power delivery surface 156 and the power receiver assembly 130 as shown for illustration by arrows 205 in FIG. 22.

Flux must pass through the “air” gap separating the surface 156 of power delivery coil assembly 500 and the power receiver assembly 130. By “air” gap, it is meant a separation 206 between magnetic materials. In these separation areas, the permeability of the medium, whether it is assumed to be of air, plastic, or otherwise, is much smaller than the permeability of typical magnet materials such as ferrite. The cross-sectional area of the “air” gap 206 is where the energy must flow to transfer energy from the surface 156 of the power delivery coil assembly 150 to the power receiver assembly 130. The larger this area is, the more coupling will exist between the power delivery surface 156 and the power receiver assembly 130. It is a feature of the present invention that the area used to couple one to another is near the theoretical maximum for a power receiver of a given size. In other words, almost the whole area of power delivery surface 156 and the mating, juxtaposed power receiver surface of the power receiver assembly 130 is filled up with magnetic material, except for small grooves or troughs 154 and a small air gap 206. If the coupling is very near one, then, in one embodiment, the voltage is transferred from the primary side (the power delivery surface 150 side) to the secondary side (the power receiver 130 side) at nearly a ratio of 1. In this case the system acts very much like a transformer.

Another example embodiment does not use ferromagnetic materials. In this example embodiment, the windings 160 are held in place by a non-ferromagnetic material such as plastic or epoxy-fiberglass arranged in the same shape as the ferromagnetic-material-based embodiment described herein.

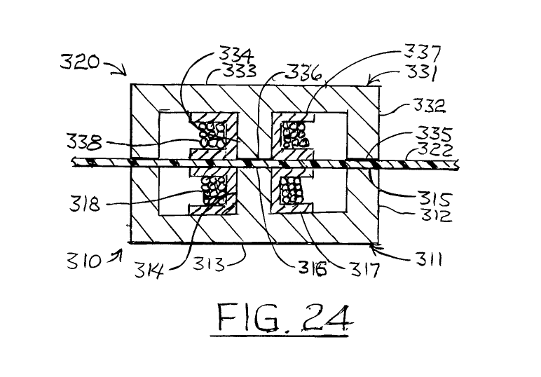

In another example implementations, each coil in both the power delivery coil assembly and the power receiver coil assembly, can be wound around half of a magnetic pot-core, such as the example half pot core 310 for the power delivery coil assembly and the other half pot core 320 for the power receiver coil assembly illustrated in FIGS. 23 and 24. There can be either one or a plurality of the half pot cores 310 in the power delivery coil assembly dispersed under the surface cover 322 (FIG. 24), and there can be one or more of the half pot cores 320 in the power receive coil assembly. As also shown in FIGS. 23 and 24, each half pot core 310 comprises a pot-shaped member 311 with a cylindrical side wall 312 and an end wall 313 with a core piece 314 protruding from the end wall 313 for a length that positions the distal end 315 of the cylindrical wall 312 and the distal end 316 of the core piece 314 at about the same distance from the end wall 313. A bobbin or spool 317 containing the wire coil 318 is positioned on the core piece 314 inside the pot-shaped member 311. Similarly, each half pot core 320 comprises a pot-shaped member 331 with a cylindrical side wall 332 and an end wall 333 with a core piece 334 protruding from the end wall 333 for a length that positions the distal end 335 of the cylindrical wall 332 and the distal end 336 of the core piece 334 at about the same distance from the end wall 333. A bobbin or spool 337 containing the wire coil 338 is positioned on the core piece 334 inside the pot-shaped member 331. When the power receiver device is placed on the power delivery surface in a position to align the two halves 310, 320, as illustrated in Figure the two half pot cores 310, 320 form a nearly complete magnetic circuit efficiently coupling the primary (power delivery pad coil 318) to the secondary (receiver coil 338). This embodiment allows for efficient magnetic coupling from power delivery pad to receiver device when the two halves 310, 320 are aligned to form a single pot core with a gap 322.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof. Also, directional words, such as upper, lower, front, back, top, bottom, and the like are used for convenience in describing features in relation the orientation of the item on the sheet of drawings and not intended to limit the orientation in actual use.

The embodiments of the invention in which an exclusive property or privilege is claimed are defined as follows:

1. Apparatus for creating an alternating magnetic field for inductive power transfer to a power receiver device, comprising:
means for providing a planar power delivery surface comprising a plurality of adjacent planar electro-magnetic pole areas in a planar power delivery surface; and
means for creating alternating polarity magnetic fields in each of the planar electro-magnetic pole areas with opposite magnetic polarities in adjacent ones of the planar pole areas.

2. The apparatus of claim 1, including a ferromagnetic core plate with a planar surface, and electrical conductor means positioned to define the plurality of electro-magnetic pole areas in the planar surface of the core plate.

3. The apparatus of claim 2, wherein the planar surface of the core plate is divided into a plurality of electro-magnetic pole areas by extending one or more electrical conductors around the areas of the planar surface that are to be the individual electro-magnetic pole areas, and driving the electrical conductor with an alternating current.

4. The apparatus of claim 2, wherein the planar surface has a plurality of troughs surrounding the pole areas, and the electrical conductor is positioned in the troughs surrounding the pole areas.

5. Apparatus for receiving power from an alternating magnetic field for inductive power transfer from a power delivery surface with a plurality of different polarity alternating magnetic field pole areas, comprising:
means for positioning at least one receiver coil pole piece over a planar surface pole area of one magnetic polarity and for positioning at least one receiver coil pole piece over another planar surface pole area that is always opposite magnetic polarity to said planar surface area of said one magnetic polarity; and
means for extracting electric current from the receiver coils and rectifying said current for DC power.

6. The apparatus of claim 5, including a plurality of core pieces extending from a yoke core in a geometric arrangement that ensures at least one of said pole pieces is positioned over a power delivery pole area of one magnetic polarity and at least another one of said pole pieces is positioned over a power delivery pole area of the opposite magnetic polarity simultaneously.

7. The apparatus of claim 5, including a core plate comprising a plurality of planar ferromagnetic pole areas with an electric conductor surrounding perimeter edges of each pole area, and electric circuit means for extracting electric current from the electric conductors when the plurality of ferromagnetic pole areas are exposed to alternating magnetic fields.

8. The apparatus of claim 7, wherein the planar pole areas are sized and shaped to match planar pole areas of a power delivery electromagnetic coil assembly that is driven to produce the alternating magnetic field.

9. The apparatus of claim 8, including a printed circuit board with two spaced apart, electrically conductive plates at different electric potentials separated by a dielectric material, and wherein the electric conductors have one end connected to one of the plates and the other end connected to the other one of the plates to form a resonating electric circuit that includes the electric conductors that surround the pole areas.

10. Magnetic pole apparatus for transferring power from a power delivery pad to a power receiver circuit inductively, comprising:
one half of a pot core with a coil in the power delivery pad;
a second half of the pot core with a coil in the power receiver circuit;
wherein said coil in the pot core half in the power delivery pad is connected electrically to an AC driver circuit, and said coil in the pot core half in the power receiver circuit is connected to circuit means for extracting electric current from the coil when the coil is exposed to an alternating magnetic field.

11. A method of providing an alternating magnetic field in a power delivery surface, comprising:
defining a plurality of electro-magnetic pole areas on a planar surface of a ferromagnetic core plate by extending an electric conductor around portions of the planar surface; and
exciting the electric conductor with an alternating current.

12. The method of claim 11, including providing a plurality of troughs in the planar surface of the core plate around the perimeters of the pole areas, and positioning the electrical conductor in the troughs in a configuration that routes electric current along adjacent edges of adjacent pole areas in a manner that generates alternating magnetic fields of opposite polarity in adjacent pole areas of the planar surface.

13. A method of delivering power inductively from a power delivery surface to a receiver device, comprising:
defining a plurality of electro-magnetic pole areas on a planar surface of a ferromagnetic core plate by providing plurality of troughs in the planar surface of the core plate around the perimeters of the pole areas, and positioning an electrical conductor in the troughs in a configuration that routes electric current along adjacent edges of adjacent pole areas in a manner that generates alternating magnetic fields of opposite polarity in adjacent pole areas of the planar surface;
exciting the electric conductor with an alternating current to generate the alternating magnetic fields of opposite magnetic polarity in the adjacent pole areas of the planar surface;
mounting a plurality of receiver coils with pole pieces in a geometric pattern on a core yoke that, when placed on the planar power delivery surface, positions at least one pole piece over one of the pole areas of one magnetic polarity and at least one other pole piece over one of the pole areas of the opposite magnetic polarity simultaneously; and
extracting electric current from the receiver coils.
